(19) United States
(12) Patent Application Publication
(10) Pub. No.: US 2026/0241583 A1
(43) Pub. Date: Aug. 20, 2026

(54) Modular Robotic End-Effector and Connector

(71) Applicant: Pickle Robot Company, Cambridge, MA (US)

(72) Inventors: Christopher M. Fitch, Arlington, MA (US); Ville Lehtonen, Arlington, MA (US)

(21) Appl. No.: 19/164,891

(22) PCT Filed: Mar. 14, 2024
(86) PCT No.: PCT/US2024/020025

§ 371 Date: Sep. 12, 2025

Related U.S. Application Data
(60) Provisional application No. 63/490,318, filed on Mar. 15, 2023.

(51) Int. Cl. B25J 15/06; B25J 15/04; B25J 19/00; B25J 19/02

(52) U.S. Cl. CPC B25J 15/0683; B25J 15/0408; B25J 19/0029; B25J 19/02

(57) ABSTRACT

A modular robotic end-effector comprising features such as a suction hose connection adapted to reduce or eliminate any forces imparted by the suction hose to the end-effector, one or more breakaway connections and one or more flexible tethers, a “bumper” or flat surface extending beyond a suction surface area to provide support for picked packages, and a suction plate with one or more separate and isolated through-holes for accommodating sensors.

### I. PRIORITY CLAIM

The present invention is related to, and claims priority from, U.S. Provisional Patent Application Ser. No. 63/490,318, filed on Mar. 15, 2023, the disclosure of which is hereby incorporated by this reference in its entirety.

### II. FIELD OF INVENTION

This disclosure relates to systems and methods for modular robotic end-effectors and grippers for robotic picking or gripping and manipulation of objects.

### III. BACKGROUND OF THE INVENTION

In the warehouse logistics industry, there is a push for the use of robotics guided by artificial intelligence algorithms to move and sort packages. This push is a continuation of a general trend of automation in industry and reflects both economic and social pressures to give physically difficult jobs to machines to perform instead of humans. Within the package handling arena there are various subcategories of automation. The current application is particularly concerned with robots in a warehouse environment that are configured to unload trailers of parcels, but the invention disclosed herein has other applications as will be evident to a person of skill in the art.

Warehouse logistics robots commonly rely on an end-effector or gripper to pick, grip, or grasp packages for handling. However, in many warehouse environments, packages that require processing may come in many different shapes, sizes, weights, and dimensions, and be constructed of different materials, such as cardboard boxes or envelopes, plastic bags, bubble mailers, etc. Different end-effectors may be designed and optimized to pick, grip, or grasp a subset of packages with certain characteristics or dimensions, but it is exceedingly difficult to provide a single end-effector that operates sufficiently well with all possible packages.

In addition, warehouse logistics robots commonly operate in complicated environments which contain obstacles with which an end-effector may collide. In the trailer unload context, for example, the end-effector must sometimes be operated in close proximity to the walls, floor, and ceiling to pick and handle packages stacked or piled in those locations. While the robot may be programmed to avoid collisions with these barriers and other hard obstacles, collisions may nonetheless take place which damage the end-effector. The present disclosure addresses or mitigates the foregoing issues and problems and includes additional features to improve the operation of robotic end-effectors.

### IV. BRIEF SUMMARY OF THE INVENTION

Embodiments of the present invention provide a mechanical interface for modular end-effectors that allows one end-effector that is adapted to handle certain types of packages to be quickly and reliably removed and replaced with another end-effector that may be adapted to handle certain different types of packages.

In another aspect, embodiments of the present invention comprise a suction hose connection for providing suction to a gripping element of an end-effector, wherein the connection is adapted to reduce or eliminate any forces imparted by the suction hose to the end-effector and instead mechanically communicate such forces directly to a robot arm.

In another aspect of the instant disclosure, embodiments of the present invention include a connection between an end-effector and a robot arm comprising one or more breakaway connections and one or more flexible tethers. In a first mode, the end-effector is firmly secured to the robot arm with the one or more breakaway connections and each of the one or more flexible tethers are secured to both the end-effector and the robot arm such that each tether is slack and not tautly connected between the end-effector and the robot arm. In a second mode, the one or more breakaway connections may be disconnected or broken, the end-effector remains connected to the robot arm by the one or more flexible tethers.

In another aspect of the instant disclosure, an end-effector comprises a suction surface area for gripping objects and “bumper” or flat surface extending beyond the suction surface area to provide support for packages picked and held with the suction surface area oriented vertically with respect to the floor.

In another aspect of the instant disclosure, an end-effector includes a low-pressure chamber, a suction plate for gripping objects, such suction plate comprising a plurality of through-holes for communicating a low-pressure created in the low-pressure chamber by the suction system to the surface of the suction plate and one or more separate and isolated through-holes for accommodating sensors. These separate and isolated holes allow sensors that require unobstructed line-of-sight to be mounted within the boundary of active suction.

### V. BRIEF DESCRIPTION OF THE DRAWINGS

FIG. 1 shows one embodiment of a modular robotic end-effector connector in accordance with the teaching of this invention.

FIG. 2 illustrates one embodiment of a modular robotic end-effector connector comprising a quick-release feature.

FIG. 3 illustrates one embodiment of a modular robotic end-effector connector comprising a vacuum or suction hose connection.

FIG. 4 illustrates one embodiment of a modular robotic end-effector connector comprising a break-away or compliance mechanism and feature.

FIG. 5 shows an overhead view of an embodiment of a modular robotic end-effector connector comprising a quick-release feature.

FIG. 6 illustrates one embodiment of a modular robotic end-effector with a “bumper.”

FIG. 7A-B shows the effect of a “bumper” on a package picked in while the suction surface area of the gripper is oriented vertically.

FIG. 8 illustrates one embodiments of a modular robotic end-effector comprising through-holes for operation of vacuum or suction force and separate and isolated through-holes for mounting of sensors.

### VI. DETAILED DESCRIPTION

Embodiments of the present disclosure comprise a modular, swappable air suction gripper (or end-effector) with mounting hardware for a robotic arm. Certain embodiments of the present disclosure allow human operators to quickly remove and replace a gripper with similar grippers of different specifications in the correct orientation. Certain embodiments of the present disclosure comprise features that protect the hardware from damage and stop robot operation in the event of a collision and distribute potentially disruptive mechanical forces away from sensitive components. Certain embodiments assist in stabilizing gripped objects by provision of a “bumper” extending below the gripping surface of the gripper when gripping surface is oriented vertically. Certain embodiments permit the installation of additional sensors for enhanced robotic arm functionality.

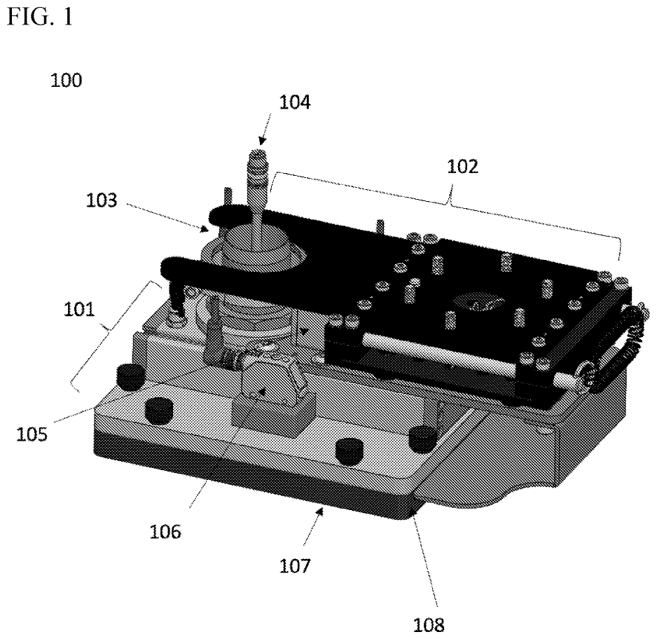

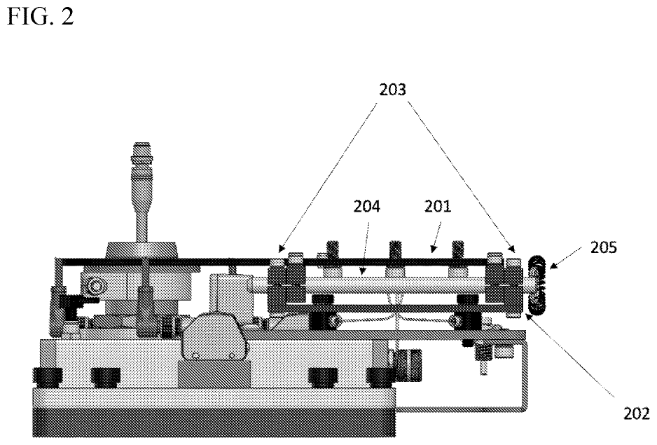

In one embodiment, illustrated in FIG. 1, a gripper apparatus and system 100 of the present disclosure includes a gripper tool assembly 101 connected to a robotic arm via a quick release assembly 102 and actuated by vacuum power through a hose connector assembly 103. Cabling 104 from an electronics box 105 for attached rangefinders 106 and other sensors and instruments runs through an attached vacuum hose for integration with robotic control equipment. Objects adhere to the vacuum pad 107 when suction is passed from a vacuum hose through the hose connector assembly 103, then through vacuum channels in the vacuum plate 108, and finally through corresponding holes in the vacuum pad 107, allowing an attached robotic arm to lift and manipulate an adhered object.

### A. Quick Mount

In some embodiments the present invention comprises a mechanism that allows a operators to quickly remove and replace a gripper with similar grippers of different specifications in the correct orientation. Because there is no single gripper that is universally suited for all robotic tasks, it is often desirable to change grippers utilized by a robot depending on the immediate requirements of the task. In the trailer unload context, for example, while the overall universe of package types encountered is very large, a single trailer often may contain packages of only a few or several different types. The present invention allows a gripper that is optimized or well-suited for the particular subset of packages to be handled during a given unload to be fitted.

FIG. 2 illustrates one embodiment of a swappable gripper. A quick release assembly consists of two interlocking sub-assemblies: an arm-side quick release assembly 201 and a tool-side quick release assembly 202. The arm-side quick release assembly 201 is mechanically affixed or connected to the robot arm. The tool-side quick release assembly 202 is mechanically affixed or connected to the end-effector. The arm-side quick release assembly 201 and tool-side quick release assembly 202 may each comprise two pairs of rod clamps 203 which mechanically attach to two rods 204. The two rods 204 may each have a different diameter and each pair of rod clamps 203 may also have corresponding different diameters, such that the orientation of the tool-side quick release assembly 202 with respect to the arm-side quick release assembly 201 is immediately obvious to a human operator. When the two pairs of rod claims 203 are aligned in the correct orientation, they each accept a rod 204 of corresponding diameter thereby forming a secure attachment between the arm-side quick release assembly 201 and the tool-side quick release assembly 202 and allowing rapid changing of gripper tool assemblies and preventing (by virtue of the different diameter rods 204 and different diameter rod clamps 203) incorrect orientation of the gripper tool assembly 101 vis-à-vis an attached robotic arm. The rods 204 may be connected at one end with spongy cord or another attachment 205, so that they remain co-located and are not separated from one another even when not in place within the rod clamps 203.

In some embodiments, a gripper apparatus and system 100 of the present disclosure is operated with a compatible docking station that allows automated swapping of similar grippers of different specifications without any hands-on user intervention. In such an embodiment, a connected control system could initiate a gripper swap to accommodate different sizes or weights of lifted objects.

### B. Hose Connector Assembly

Some embodiments of the present invention comprise a suction hose connection for providing suction to a gripping element of an end-effector, wherein the connection is adapted to reduce or eliminate any forces imparted by the suction hose to the end-effector and instead mechanically communicate such forces directly to a robot arm. In some applications, imparting unexpected forces to the end-effector may introduce unwanted displacement of the end-effector with respect to the robot arm. The probability of this unwanted displacement is increased when the attachment of the end-effector to the robot arm includes mechanical components that introduce some compliance in the connection.

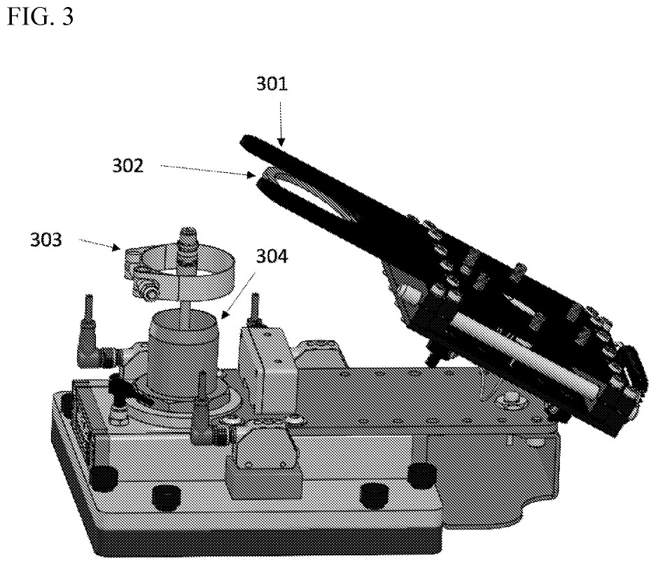

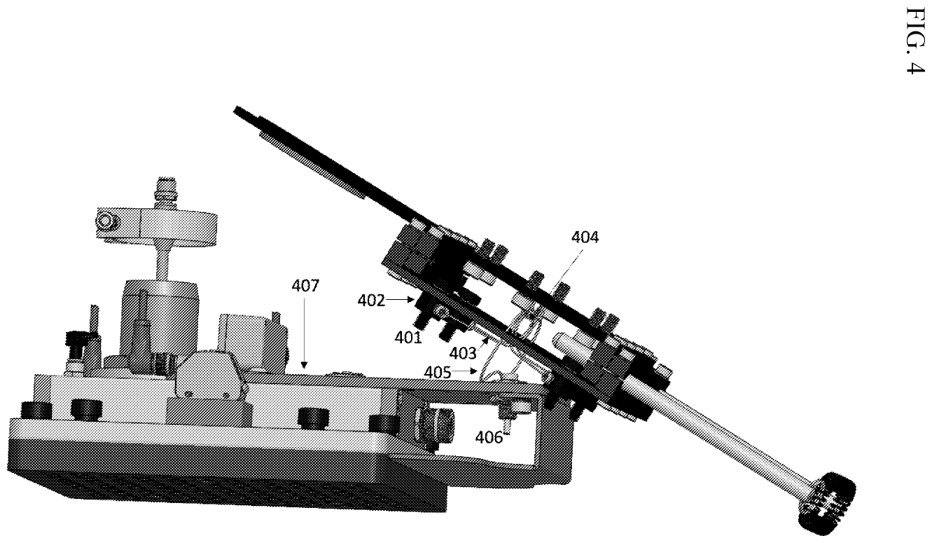

FIG. 3 shows one embodiment of a suction hose connection in accordance with the current invention. When connected, a vacuum hose passes through a u-shaped extension 301 on the arm-side quick release assembly, as well as through a free-floating ring 302 and a hose clamp 303, which secures the hose to the hose connector 304.

To keep a vacuum hose clear of an operating robotic arm, vacuum hoses are sometimes attached to retractor systems, which apply force to the vacuum hose. In the present embodiment, forces from a retractor system on a vacuum hose pull away from the gripper tool assembly and engage the free-floating ring 302, which transmits the force through the u-shaped extension to an attached robotic arm, 301 which can better compensate for such forces than if they were applied directly to the gripper tool assembly 101. Additionally, the u-shaped extension 301 allows a vacuum hose to slip through the quick release assembly, arm side 201, protecting the vacuum hose and facilitating a gripper tool assembly breakaway event in a collision, discussed below.

In some embodiments, the hose clamp 303 is replaced with an integrated locking mechanism and cabling interface so that the vacuum hose and cabling 104 can be securely connected to the gripper apparatus and system 100 of the present disclosure in a single motion. In such an embodiment, the integrated locking mechanism and cabling interface can be unlocked and locked by a compatible docking station that allows automated swapping of similar grippers of different specifications without any hands-on user intervention.

### C. Breakaway Connection

Some embodiments of the present invention include a connection between an end-effector and a robot arm that provide compliance and allows the end-effector to break away from the robot arm when encountering an obstacle at a force that is less than would damage the end-effector.

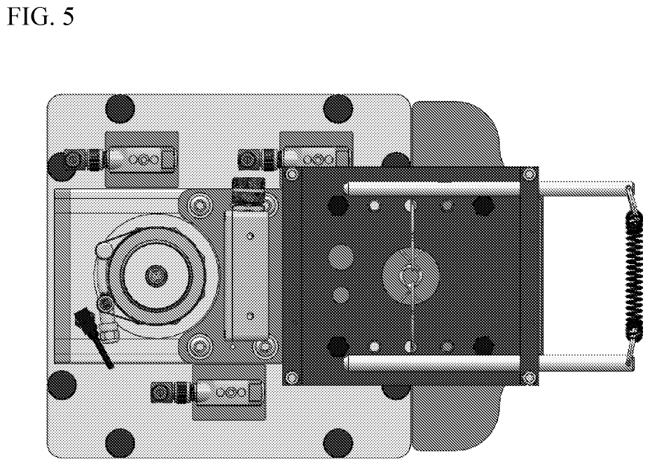

FIG. 4 shows one embodiment of a breakaway connection in accordance with the instant invention. The tool-side quick release assembly 202 is fastened to the gripper tool assembly 101 via four nylon bolts 401 that each pass through the top of the tool-side quick release assembly 202, then through an aluminum standoff 402, and finally through threaded holes in the top of the gripper tool assembly 101. Each aluminum standoff is attached to a lanyard 403 that passes through a hole in the center of the tool-side quick release assembly 202 and fastens to a twisted ring 404. A separate lanyard 405 connects the twisted ring 404 on the arm-side quick release assembly to the breakaway plate 407. A first end of lanyard 405 is attached to twisted ring 404. Lanyard 405 then passes through the tool-side quick release assembly, attaches to breakaway plate 407 roughly in the center of its length, and returns through the tool-side quick release assembly. A second end of lanyard 405 is then also attached to twisted ring 404. FIG. 5 shows the orientation of the twisted ring 404 and attached lanyards 403, 405 vis-à-vis the quick release assembly, tool side 202.

In the event the gripper tool assembly 101 collides with an object with sufficient force, the nylon bolts 401 fastening the quick release assembly 102 to the gripper tool assembly 101 break, allowing the gripper tool assembly 101 to fall away from the quick release assembly 102 without either assembly sustaining significant damage. In a breakaway event, a metal proximity sensor 406 detects a change in distance between the metal proximity sensor 406 and the bottom of the quick release assembly 102 and may send a signal via electronics box 105 and attached cabling 104 to a robotic arm control system to communicate the detachment or break-away event.

In some embodiments, additional metal proximity sensors 406 are placed on the top of the gripper tool assembly 101 to determine the rate and angle of separation of the quick release assembly 102 from the gripper tool assembly 101 for various purposes, for example collision analysis or machine learning algorithm training.

### D. Torque Bumper

Some embodiments of the invention of the instant disclosure comprise an end-effector with a suction surface area for gripping objects and a “bumper” or flat surface extending beyond the suction surface area to provide support for packages picked and held with the suction surface area oriented vertically with respect to the floor.

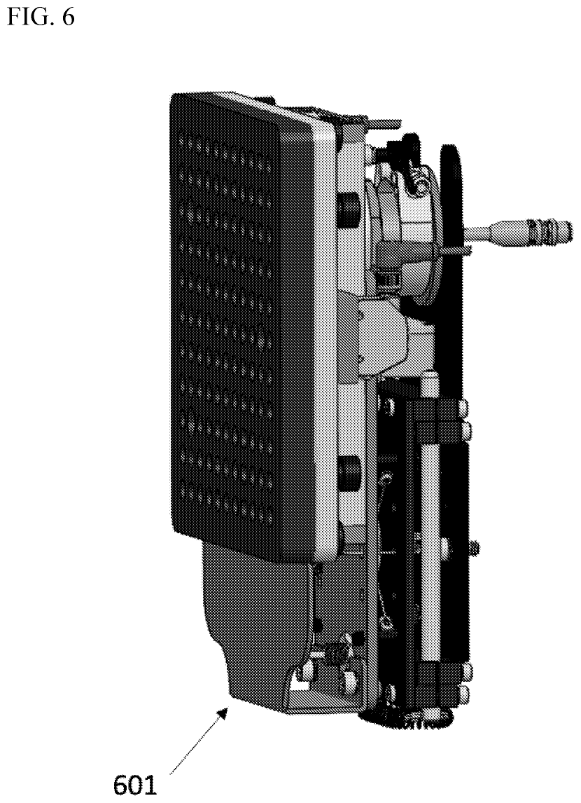

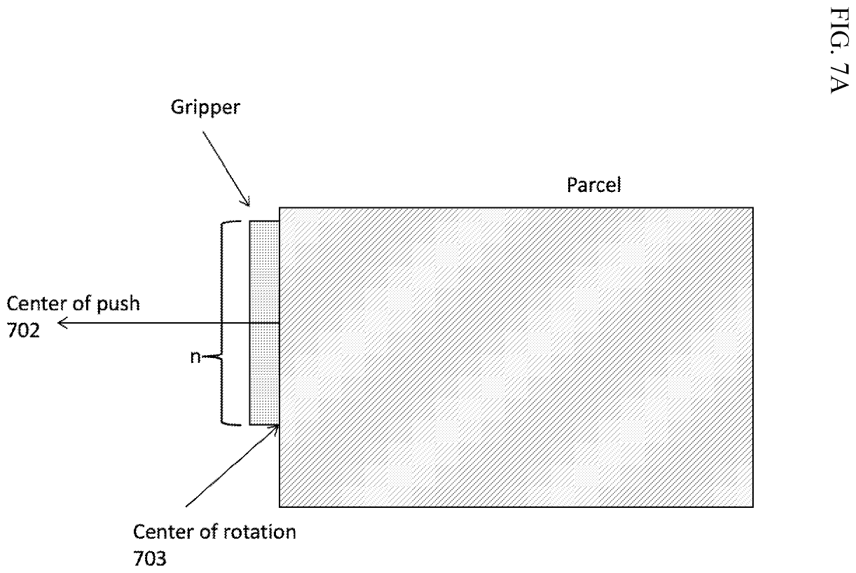

FIG. 6 shows an embodiment comprising such a “bumper.” In the orientation shown in FIG. 6, where the suction surface area is oriented vertically, gravity is pulling on a horizontally-held adhered object and creates moment forces that pull the object down and rotate it away from the gripper tool assembly 101. The torque bumper 601 lowers the point of the axis of rotation for the torque portion of such moment forces, which stabilizes the adhered object and reduces disruptive forces on the gripper apparatus and system 100.

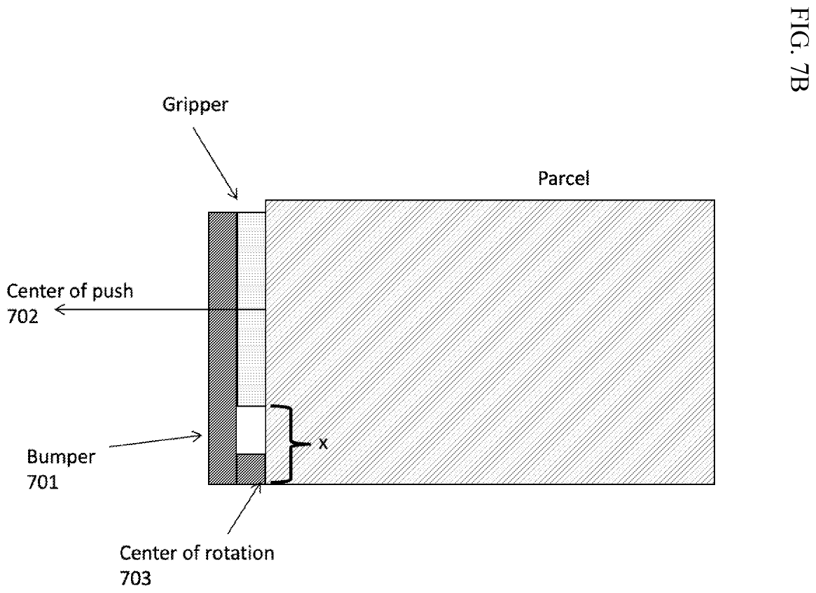

FIGS. 7A-B shows how addition of a torque bumper can lowers the axis of rotation for a package grasped and held via suction through the air suction gripper, thereby reducing the set of circumstances under which a parcel will peel away from the gripper.

With reference to FIG. 7A, the force holding the parcel to the gripper equals the pressure applied by the gripper divided by the area of contact between the parcel and the gripper:

$$F = P * A \qquad ( Eq . 1 )$$

where F is force, P is pressure, and A is area. The moment that may cause a parcel to peel away from the gripper is:

$$M = F * d \qquad ( Eq . 2 )$$

where M is the moment, F is force, and d is distance from the center of the suction head 702 to the center of rotation 703. Substituting Eq. 1 into Eq. 2 and assuming a square suction area with side length n, yields a moment of:

$$M = \frac{n}{2} * {n}^{2} * P = \frac{{n}^{3}}{2} * P \qquad ( Eq . 3 )$$

As illustrated by FIG. 7B, however, adding a bumper below the suction gripper, increases the distance between the center of the suction head 702 to the center of rotation 703. Now, the moment is:

$$M = ( \frac{n}{2} + x ) * {n}^{2} * P = ( \frac{{n}^{3}}{2} + x * {n}^{2} ) * P \qquad ( Eq . 4 )$$

Note that the moment required to peel the parcel away from the gripper has increased by x*n²*P.

In some embodiments, the torque bumper's 701 length and width vary to accommodate different sizes and weights of lifted objects.

### E. Sensors and Sensor Channels

Some embodiments of the instant invention include a vacuum pad comprising through-holes (or channels) that apply suction or vacuum force to an object to be picked and separate through-holes (or channels) that are physically isolated from the suction forces for mounting sensors.

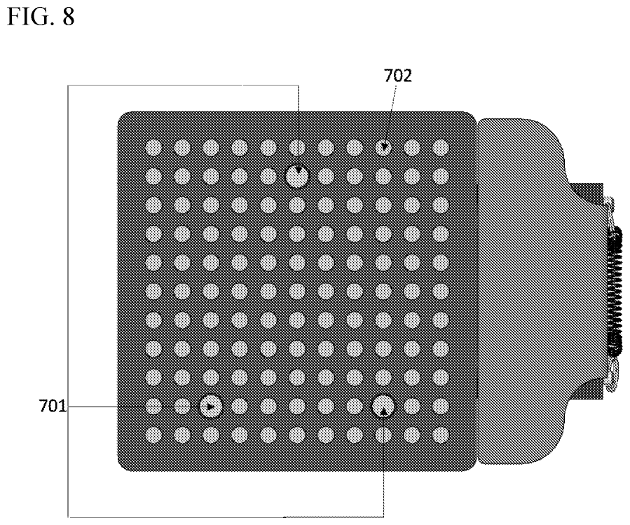

FIG. 8 shows an embodiment of the instant invention comprising such separate and isolated through-holes for sensors. In this embodiment, the sensors to be mounted to the end-effector are laser rangefinders, which require a clear line of sight to the object to be sensed. Laser light from the rangefinders 106 mounted on top of the vacuum plate 107 passes through sensor channels 801 that are cut into both the vacuum plate and the vacuum pad and pneumatically isolated from the vacuum channels 802. These sensor channels allow sensors to gather data on the gripper apparatus and system's 100 surroundings, including data used to determine the angle of a flat object below the gripper apparatus and system 100 relative to the plane of the vacuum pad 108.

In some embodiments, the laser rangefinders 106 are replaced with video cameras connected to a robotic control system for various purposes, for example reading labels on lifted objects, sensing the environment around the gripper apparatus and system, or determining the dimensions of lifted objects.

The foregoing exemplary descriptions and the illustrative embodiments of the present disclosure have been explained in the drawings and described in detail, with varying modifications and alternative embodiments being taught. While the disclosure has been so shown, described and illustrated, it should be understood by those skilled in the art that equivalent changes in form and detail may be made therein without departing from the true spirit and scope of the disclosure, and that the scope of the present disclosure is to be limited only to the claims except as precluded by the prior art. Moreover, the disclosure as disclosed herein may be suitably practiced in the absence of the specific elements, which are disclosed herein.

1. A robotic system comprising:
a robotic arm;
an electronics box comprising robotic control equipment;
an end-effector comprising
one or more sensors and instruments and
a gripper tool assembly connected to the robotic arm with a quick release assembly,
wherein the gripper tool assembly comprises a vacuum pad with a plurality of vacuum channels formed through the vacuum pad terminating in holes in a face of the vacuum pad;
a vacuum hose in mechanical communication with the gripper tool assembly through a hose connector assembly, wherein the hose connector assembly is configured to apply vacuum to a low pressure chamber and the plurality of vacuum channels formed through the vacuum pad communicate a low pressure created in the low pressure chamber to the surface of the vacuum pad; and
a cabling assembly to electrically connect the electronics box with the one or more sensors or instruments, wherein the cabling assembly is mechanically disposed within an internal space of the vacuum hose.

2. The robotic system of claim 1 wherein the quick release assembly comprises:
a first quick release sub-assembly mechanically connected to the robotic arm and comprising a first pair of rod clamps; and
a second quick release sub-assembly mechanically connected to the gripper tool assembly and comprising a second pair of rod clamps;
wherein the first quick release sub-assembly and the second quick release sub-assembly are configured to interlock with one another via a first rod and a second rod, each of which is retained by one of the first pair of rod clamps and one of the second pair of rod clamps.

3. The robotic system of claim 2 wherein the diameter of the first rod and the diameter of the second rod are different.

4. The robotic system of claim 2 wherein the hose connector assembly comprises:
a U-shaped extension mechanically connected to the first quick release sub-assembly;
a free-floating ring;
a hose attachment mechanism; and
a hose connector mechanically connected to the gripper tool assembly;
wherein the vacuum hose passes through the U-shaped extension and free-floating ring and the hose attachment mechanism secures the vacuum hose to the hose connector,
wherein the U-shaped extension is configured to receive substantially all mechanical forces applied to the vacuum hose by the robotic system.

5. The robotic system of claim 4 wherein the hose attachment mechanism is a hose clamp.

6. The robotic system of claim 4 wherein the hose attachment mechanism comprises an integrated mechanical locking mechanism and cabling interface to connect the vacuum hose and the cabling assembly to the end-effector in a single motion.

7. The robotic system of claim 2 wherein the second quick release sub-assembly is mechanically connected to the gripper tool assembly via a plurality of breakaway connections.

8. The robotic system of claim 7 wherein
each of the plurality of breakaway connections comprises a nylon bolt passing through the second quick release sub-assembly, an aluminum standoff, and a threaded hole in the gripper tool assembly, and
wherein each nylon bolt is configured to yield when a force applied to the gripper tool assembly exceeds a threshold such that the gripper tool assembly detaches from the second quick release assembly.

9. The robotic system of claim 8 wherein each aluminum standoff and the gripper tool assembly is attached to the second quick release subassembly via a lanyard such that each aluminum standoff and the gripper tool assembly are retained and not dropped upon detachment.

10. The robotic system of claim 7 further comprising one or more proximity sensors located on top of the gripper tool assembly wherein the one or more proximity sensors are configured to detect the rate of detachment or the angle of separation between the second quick release sub-assembly and the gripper tool assembly upon detachment.

11. The robotic system of claim 1 wherein the vacuum pad further comprises:
a suction surface area through which all of the plurality of vacuum channels are disposed; and
a flat surface area extending beyond the suction surface area in a first direction;
wherein the suction surface area and the flat surface area form a contiguous surface, and
wherein the robotic system is configured to grip an object with the suction surface oriented in a vertical plane with the first direction of the flat surface oriented in a downward direction such that the flat surface provides support for the object.

12. The robotic system of claim 1 wherein the vacuum pad further comprises one or more through-holes that are pneumatically isolated from the low pressure chamber and the plurality of vacuum channels wherein the one or more through-holes are configured to accommodate sensors that require an unobstructed line-of-sight within a boundary of active suction.
